(19) United States
(12) Patent Application Publication
(10) Pub. No.: US 2016/0115085 A1
(43) Pub. Date: Apr. 28, 2016

(54) NEW PROCESS OF MANUFACTURING CEMENTED CARBIDE AND A PRODUCT OBTAINED THEREOF

(71) Applicant: SANDVIK INTELLECTUAL PROPERTY AB, Sandviken (SE)

(72) Inventors: Susanne NORGREN, Huddinge (SE); Jose GARCIA, Enskededalen (SE)

(21) Appl. No.: 14/894,392

(22) PCT Filed: May 28, 2014
(86) PCT No.: PCT/EP2014/061162

§ 371 Date: Nov. 27, 2015

(30) Foreign Application Priority Data
May 31, 2013 (EP) 13170070.0

(51) Int. Cl. C04B 35/56; C22C 29/00; C22C 29/02

(52) U.S. Cl. CPC C04B 35/5626; C22C 29/02; C22C 29/005

(57) ABSTRACT

A process of manufacturing cemented carbide and to a product obtained thereof wherein hex doped WC is subjected to nitrogen before and/or during sintering.

### TECHNICAL FIELD

The present relates to a process of manufacturing cemented carbide and to a product obtained thereof and to the use thereof.

### BACKGROUND

Cemented carbide is used for manufacturing sintered bodies for e.g. cutting tools, wear parts, rock drill bits, etc. The cemented carbide industry is also interested in producing materials that are hard and have wear resistant to be used at high speed conditions. This is achieved by coating cemented carbides with layers of e.g. TiN, Ti(C,N), (Ti,Al)N and/or Al₂O₃. WC—Co alloys are the most frequently used material for rock drilling. The knowledge about hard metals and methods to improve the hard WC phase is important for the development of new and improved rock drills.

US 2005/0025657 discloses a method of making a fine grained tungsten carbide-cobalt cemented carbide, the method comprises mixing, milling according to standard practice followed by sintering. By introducing nitrogen at a pressure of more than 0.5 atm into the sintering atmosphere after dewaxing but before pore closure, a grain refinement including reduced grain size and less abnormal grains can be obtained.

WO 2012/145773 relates to a tungsten monocarbide powder formed of a hexagonal tungsten carbide doped with at least one group 4 and/or group 5 and/or group 7 transition metal (excluding Tc). The document also discloses a two-stage method for producing novel doped hexagonal tungsten carbides via (W,Me)₂C to (W,Me)C.

Reichel, B et al (International Journal of Refractory Metals and Hard Materials 28 (2010) 638-645) discloses a method for the production of doped hard metals with individual carbides. According to the method, double or triple alloyed sub-carbides of the type MexCoyCz (wherein Me=metal such as W, V, Cr, Ta, Ti etc.) are used as starting materials to produce hardmetals containing WC or WC/cubic carbide phase embedded in a Co binder phase. However, this method has problems with adjusting the carbon content to produce defect free structures (such as eta-phase or free-graphite) since extra carbon need to be added to the starting MexCoyCz subcarbides to produce the final desired microstructure. Furthermore, it has never been proved that by using the method described a sintered hardmetal containing hex WC doped with any cubic carbide can be produced.

When using hex doped WC, the main challenge from a processing point of view is to avoid the precipitation of the doping transition metal, e.g. in the form of tantalum carbide or carbonitride out of the hex doped WC phase during the sintering process and none of the methods disclosed above solves this problem. Additionally, for certain applications of cemented cubic carbides there is also a challenge to avoid precipitation of cubic carbides or other additional carbides or carbonitrides as these precipitates will reduce the toughness of the obtained sintered product.

Thus, the process and the product obtained thereby disclosed in the present disclosure will migrate and/or provide a solution to the problems mentioned above.

### SUMMARY OF THE INVENTION

Hence, the present disclosure provides a process of manufacturing a cemented carbide, said process comprises the steps of:

a) forming a slurry comprising a milling liquid, binder metal and hard constituents,

wherein the hard constituents comprise hex doped WC;

b) subjecting said slurry to milling and drying;

c) subjecting the powder mixture obtained from b) to pressing and sintering;

wherein the hex doped WC is subjected to nitrogen before and/or during sintering. It has surprisingly has been found that by subjecting the hex doped WC to nitrogen before and/or during the sintering process, the above-mentioned problems will be solved or migrated. Without being bound to any theory, it is believed that the nitrogen has an effect on the solubility of the doping elements in the hexagonal WC. Thus, by applying the process as defined hereinabove or hereinafter, the precipitation of the doping out of the hex doped WC is controlled and therefore a cemented carbide containing hex doped WC grains can be produced. Without being bound to any theory, it is believed that one reason for the limited grain growth may be the very low solubility of nitrogen in the liquid binder metal and solid binder metal-rich phases.

The present process as defined hereinabove or hereinafter therefore provides a possibility and an opportunity to tailor a cemented carbide by combining the present process and the doping level of the WC. Additionally, the present process as defined hereinabove or hereinafter will provide for a reduced volume fraction of gamma-phase in the sintered product as a certain content of the transition metal elements forming the gamma-phase will remain as solid solution in the hex doped WC.

The present disclosure also relates to the use of a process of manufacturing of a cemented carbide as defined hereinabove or hereinafter for making a cutting tool.

Additionally, the present disclosure provides a cemented carbide obtainable according to the process as defined hereinabove or hereinafter. Furthermore, the present disclosure also provides a cutting tool obtainable according to the process as defined hereinabove or hereinafter. The cemented carbide and thereby the cutting tool encompass enhanced hardness-to-toughness ratio compared to conventional cemented carbides as the hardness of the hex doped WC is reduced and the obtained cemented carbide and thereby said cutting tool can, due to this enhanced hardness-to-toughness, comprise less binder metal, such as Cr, Mo, Fe, Co and/or Ni, and still encompass the desired properties.

### BRIEF DESCRIPTION OF THE FIGURES

FIG. 1 discloses a schematic figure of the process as defined hereinabove or hereinafter.

FIG. 2 discloses one example of a picture used for measuring the nano indentation

FIG. 3 discloses for Sample 2 (TaC+WC), LOM image in 2000× magnification and polarized light. The dark phase is WC, yellow is TaC and the light colored is the binder phase. Unetched (A) and etched with Murakami for 2 min. (B).

FIG. 4 discloses for Sample 3 ((W,Cr)C+Co), LOM image in 2000× magnification and polarized light. The light colored phase represents the binder phase and the darker is WC. Unetched (A) and etched with Murakami for 2 min. (B).

FIG. 5 discloses for Sample 5 (W,Cr)C+(W,Ta)C., LOM image in 2000× magnification and polarized light. The light colored phase represents the binder phase and the darker is WC. Unetched (A) and etched with Murakami for 2 min. (B).

FIG. 6 discloses for Sample 6 (WC+TaC+Cr₃C₂), LOM image in 2000× magnification and polarized light. The light colored phase represents the binder phase and the darker is WC. Unetched (A) and etched with Murakami for 2 min. (B).

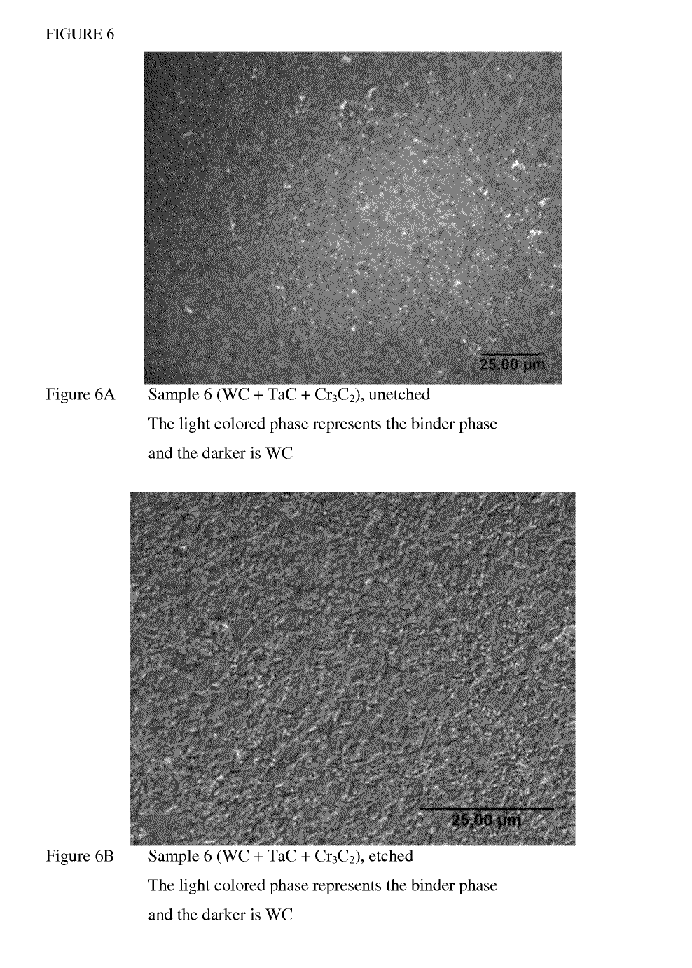

### DEFINITIONS

As used herein unless stated otherwise, the terms “doped WC” and “hex doped WC” and “hexagonal doped WC”, as used interchangeably, are intended to mean that the tungsten atoms within the hexagonal crystal structure of the tungsten carbide are partly replaced with atoms of the transition metal(s) selected from element group 4 and/or element group 5 and/or element group 7 (transition metals), excluding Tc. Examples of, but not limited to, transition metal are Ta, Cr and Nb. Hex doped-WC may also written as hex(Me,W)(C) or hex(Me,W)(C,N), wherein Me is any of the transition metals disclosed above.

The terms “hex-WC” and “hexagonal WC”, are used interchangeably herein and are intended to mean a tungsten carbide having a hexagonal structure.

As used herein unless stated otherwise, the term “hard constituents” is intended to include WC, doped WC, carbides, nitrides, carbonitrides, borides, carboxides, carboxynitrides and mixtures thereof of the elements corresponding to the element groups 4, 5 and 6 of the periodic table. Examples of carbides, nitrides, carbonitrides, borides, carboxides, carboxynitrides and mixtures thereof of the elements corresponding to the element groups 4, 5 and 6 of the periodic table, but not limited to, are TaC, Cr₃C₂ and NbC. The hard constituents are in the form of powder when dry.

According to the present disclosure, the term “cutting tool” is used for is any tool that is used to remove material from a work piece by means of shear deformation, examples of, but not limiting, cutting tools are inserts, end mills, mining tool, bits and drills.

Additionally, the term “sintered body” is intended, unless stated otherwise, to include a cutting tool.

By the term “gamma phase” is herein meant the cubic phase formed during sintering. The gamma phase is usually described as (W,Me₁, Me₂ . . . )(C,N,O,B), wherein Meₓ is Hf, Ta, Nb, Cr, Mo, W, Mn, Re, Ru, Fe, Co, Ni and Al and the phase has a cubic structure. In order to form the gamma phase, a certain amount of cubic carbides needs to be present for the gamma phase to be formed. The most common cubic carbides used for creating the gamma phase are TiC, TaC and NbC, however, cubic carbides of other elements can also be used. When manufacturing a straight grade, i.e without gradient, of cemented carbide, gradient forming elements such as Ti, Zr and V are usually excluded.

### DETAILED DESCRIPTION OF THE INVENTION

The present invention relates to a process of manufacturing a cemented carbide, said process comprises the steps of:

a) forming a slurry comprising a milling liquid, binder metal and hard constituents,

wherein said hard constituents comprise hex doped WC;

b) subjecting the slurry obtained from step a) to milling and drying;

c) subjecting the powder mixture obtained from b) to pressing and sintering;

wherein the hex doped WC is subjected to nitrogen before and/or during sintering. The sintering may be performed in a temperature range of from 500-1500° C. with a nitrogen pressure in the range of from 1 mbar and 200 bar. Hence, the present disclosure relates to a process of producing cemented carbides comprising hex doped WC. The WC has been doped with doping elements selected from the element groups 4, 5 and/or 7 (excluding Tc). Examples of such elements are Ta, Nb, Cr and mixtures thereof. As the process as defined hereinabove or hereinafter is used for manufacturing straight grades of cemented carbides, i.e. the cemented carbide does not comprise any gradient, elements know to be gradient formers are preferably avoided.

In order to form a hexagonal structure of the doped WC, the amount of doped element needs to be restricted. If the amount of doped element exceeds the maximum solid solubility in the hex-WC, the WC will form a cubic carbide phase of the type (W,Me)C, wherein Me is the doping element, which is not desirable. The exact amount of doped element that may be added is somewhat dependent on the specific doping element of choice but the amount of doped element should not exceed 3 wt % of the total weight of the hex doped WC.

According to one embodiment of the present invention, the hard constituents used in the process as defined hereinabove or hereinafter are selected from hex doped WC, WC, TaC, NbC, Cr₃C₂ and mixtures thereof. According to another embodiment of the present invention, said hard constituents is selected from hex doped WC, WC, TaC and mixtures thereof. According to yet another embodiment of the present invention, the amount of WC comprised hard constituents does only consist of hex doped WC. According to a further embodiment of the present invention, said hard constituents is selected from hex doped WC and TaC.

According to one embodiment of the present disclosure, the powder fractions, i.e. the hard constituents and the binder metal and any other optionally added powder, may be added in the following amounts: WC and hex doped WC in the range of from 65 to 90 wt %, such as 70 to 90 wt %; binder metal, such as Co, in the range of from 3 to 15 wt %, such as 5 to 9 wt %; Ta (Ta may be in the form of TaC or TaN or Ta(C,N) or mixtures thereof in the doped WC) in the range of from 1 to 5 wt %, such as 1 to 3 wt % and Cr (Cr is usually added in the form of Cr₃C₂) in the range of from 0 to 20 wt %.

According to the present disclosure, in the process of manufacturing a cemented carbide as defined hereinabove or hereinafter, the hex doped WC is subjected to nitrogen gas before sintering.

Also, according to the process of manufacturing a cemented carbide as defined hereinabove or hereinafter, the doped WC is subjected to nitrogen gas during sintering. This may be combined with the subjection to nitrogen gas before the sintering.

The nitrogen may also be added during the open porosity stage of the sintering process, as well as during the entire process, or already present in the raw material. Also, according to the present invention and in relation to what is written above regarding the nitrogen subjection, it is also possible to subject the hex doped WC to nitrogen during the manufacture of the hex doped WC. Said hex doped WC (W,Me, . . . )(C,N) or (W,Me, . . . )C may thereafter be used in the process as described hereinabove or hereinafter.

According to the present disclosure, the hex doped WC is doped with a transition metal selected from Ta, Nb, Cr and mixtures thereof, preferably the transition metal is Ta. The process used for doping hexagonal WC is described in WO 2012/145773. The average grain size of the hex doped WC when added to the slurry obtained from step a) is in the range of from 0.4 to 25 μm, such as of from 2 to 20 μm. The grain size of the cubic carbides, e.g. TaC, usually are in the range of from 0.8 and 2.5 μm.

The binder metal can either be a powder of one single binder metal or a powder blend of two or more metals or a powder of an alloy of two or more metals. The binder metals are selected from the group consisting of Cr, Mo, Fe, Co, Ni and mixtures thereof, preferably from Co, Fe or Ni, most preferably Co. The grain size of the added binder metal is in the range of from 0.5 to 3 μm, preferably from 0.5 to 1.5 μm. The amount of binder metal added separately is dependent on the content of the hard constituent as defined hereinabove or hereinafter. Hence, the amount of binder metal added is the amount required to achieve the aimed binder metal content in the final product. The total binder metal content in the final product is in the range of from 2 to 15 wt %.

The hard constituents as defined hereinabove or hereinafter, the binder metal and an organic binder are mixed by a milling operation, either in a ball mill, attritor mill or pearl mill. The milling is performed by first forming a slurry comprising the binder metal, said hard constituents and the organic binder. The slurry is then milled to obtain a homogenous slurry blend. The milling is performed in order to de-agglomerate and to reduce the powder grain size. The milling time varies, as it is dependent on both the type of mill used and on the quality of the powders to be milled and on the desired grain size. Suitable milling times are from between 10 to 120 h for a ball mill or from between 10 to 35 h for an attritor mill. Milling bodies may be used. Also, a lubricant may be added in order to improve the strength of the green body. Any liquid commonly used as a milling liquid in conventional cemented carbide manufacturing processes may be used, for example water, alcohol, organic solvents or mixture thereof.

An organic binder is added to the slurry in order to facilitate the granulation during the following drying operation, such as spray drying or pan-drying, but it will also function as a pressing agent for any of the following pressing and/or sintering operations. The organic binder may be any binder commonly used in the art, such as paraffin, polyethylene glycol (PEG), long chain fatty acids and mixture thereof. The amount of organic binder used is in the range of from 15 and 25 vol % based on the total dry powder volume, the amount of organic binder is not included in the total dry powder volume.

According to the present disclosure, recycled WC also called PRZ or recycled cemented carbide scrap is added to the slurry before step b) in an amount up to or equal to 50 wt %. The amount added will depend, as known to the skilled person, on the composition of the scrap and on the desired composition of the final cemented carbide. PRZ comprises the elements W, C, Co, and at least one or more of Ta, Ti, Nb, Cr, Zr, Hf and Mo. The recycling process is usually performed by either metallurgical or chemical means, such as by the zinc recovering process, electrolytic recovery and, extraction or oxidation, which are all known to the skilled person.

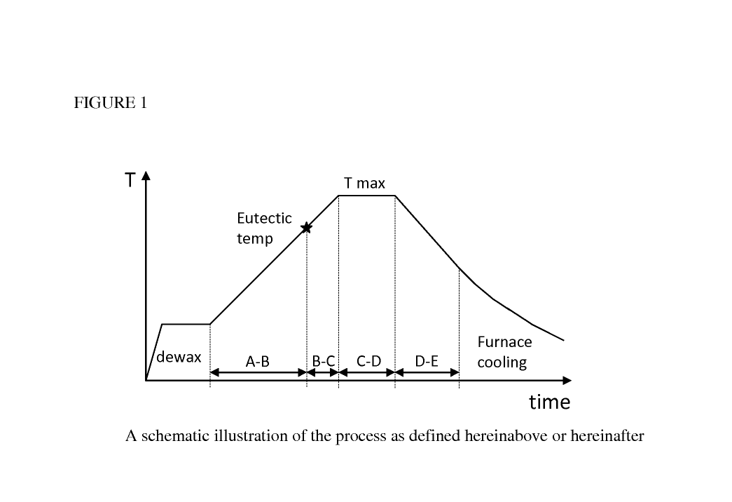

Green bodies are subsequently formed from the dried powders/granules by a pressing operation such as uniaxial pressing, multiaxial pressing etc. The green bodies formed from the dried powders/granules are subsequently sintered according to a known sintering methods, such as liquid phase sintering. The liquid phase sintering may be performed in combination with Sinter HIP. The sintering process may be performed in vacuum, in argon atmosphere or in nitrogen atmosphere or a combination thereof (See FIG. 1). FIG. 1 schematizes the main steps in a sintering cycle which are modified in the present invention. These steps may vary depending on various factors. For the particular examples given in this disclosure segment A-B is the step initiating after the dewaxing period is finished and the temperature is raised up to the formation of melting of the sintered alloy (eutectic temp); segment B-C corresponds to the sintering step from the eutectic temperature to the maximum sintering temperature (T max) at liquid phase sintering; segment C-D is the isothermal sintering at the maximum sintering temperature (T max) and segment D-E is the cooling step from the maximum sintering temperature to a temperature far below the eutectic point of the sintered cemented carbide. The step wherein the material cools down until the process finishes is denoted “Furnace cooling”. Additionally, in order to control the growth of the WC grains during sintering, compounds, such as Cr₃C₂ and TaC, may be added before the sintering is performed.

According to the present disclosure, cemented carbides and/or cutting tools manufactured by using a method comprising the process as defined hereinabove or hereinafter, are coated with a wear resistant coating using CVD or PVD-technique. If a CVD-technique is used, then a CVD coating is deposited on said carbide and/or tool, the coating comprises at least one nitride or carbonitride layer, such as a TiCN layer or ZrCN layer or TiAlN layer but other nitride and/or carbonitride layers known to the skilled person may also be used as layers. Additionally, at least one α-Al₂O₃ or κ-Al₂O₃ layer may be applied on the cemented carbide and/or tool. An outermost color layer for wear detection, e.g. a TiN layer, may also be deposited.

The coating can also be subjected to additional treatments, such as brushing, blasting etc.

Hence, according to one embodiment, the process as defined hereinabove or hereinafter is usually performed by first forming a slurry by milling the hard constituents, which consist of hex doped WC and TaC, together with binder metal, selected from Co, organic binder, selected from PEG and a milling liquid (such as an alcohol and/or water) in either a ball mill or an attritor mill for several hours. The obtained slurry is subjected to a spray drying operation to form granulated cemented carbide which are used for pressing green parts that are subsequently sintered.

The cemented carbide obtainable by the process as defined hereinabove or hereinafter may be used for any type of cutting tool such as wear parts, or other types of common applications for cemented carbides. Thus, the cemented carbides obtainable by the process as defined hereinabove or hereinafter comprise a hex doped WC phase in the sintered microstructure, wherein the doping elements are selected from the element groups 4, 5 and/or 7 (except Tc). Examples of elements are Ta, Nb, Cr and mixtures thereof.

The cemented carbides obtainable by the process as defined hereinabove and hereinafter may also be used for manufacturing products for other applications wherein cemented carbides are used, for example wear parts.

The process as defined hereinabove or hereinafter and the product obtained thereof are further illustrated by the following non-limiting examples:

### EXAMPLES

Abbreviations

Co cobalt

WC tungsten carbide

PEG polyethylene glycol

wt % weight percent

Ti titanium

W tungsten

Ta tantalum

C carbon

Cr chromium

N nitrogen

N₂ nitrogen gas

μm micrometer

vol % volume percent

TaC tantalum carbide

HV hardness value

h or h. hours

° C. degrees Celsius

hex or hex. hexagonal

mbar millibar

CVD chemical vapor deposition

PVD plasma vapor deposition

Me transition metal

### Example 1

Compositions

The composition was determined using Thermo Calc software [J.-O. Andersson, T. Helander, L. Höglund, P. Shi, and B. Sundman, Thermo-Calc & DICTRA, computational tools for material science, Calphad, 2002:26(2):273-312]. The criterion was to be within the fcc+MC+WC region for a carbon activity of 0.5 in the liquid at 1410° C. and a Co composition of 6 wt %.

TABLE 1
Composition of the pre-alloyed and reference raw material in weight %. The
values are provided from the powder producer Wolfram Bergbau.

| Powder | C (wt %) | Ta (wt %) | Cr (wt %) | Grain size (μm) |
|---|---|---|---|---|
| (W, Ta) | 6.16 | 0.8439 | | 4.35 |
| (W, Cr) | 6.13 | | 0.6499 | 3.85 |
| WC | 6.15 | | | 4.25 |

The samples are listed in tables below. Each sample has one reference with the same Ta or/and Cr content. Additionally one pure sample of WC+Co was made without any additional carbide.

(W,Ta)C+Co WC+TaC+Co (reference) Same Ta content

(W,Cr)C+Co WC+Cr₃C₂+Co (reference) Same Cr content

(W,Ta)C+(W,Cr)C+Co WC+TaC+Cr₃C₂+Co (reference) Same Cr and Ta content WC+Co (pure reference)

As can be seen from below samples 1, 3 and 5 are doped.

TABLE 2

| Sample | | Ta | Cr | W | Co |
|---|---|---|---|---|---|
| 1 | (W, Ta)C + Co | 0.79 | | 86.58 | 6 |
| 2 | WC + TaC + Co | 0.79 | | 87.45 | 6 |
| 3 | (W, Cr)C + Co | | 0.59 | 87.61 | 6 |
| 4 | WC + Cr₃C₂ + Co | | 0.59 | 87.6 | 6 |
| 5 | (W, Ta)C + | 0.39 | 0.3 | 87.52 | 6 |
| | (W, Cr)C + Co | | | | |
| 6 | WC + TaC + | 0.394 | 0.295 | 87.52 | 6 |
| | Cr₃C₂ + Co | | | | |
| 7 | WC + Co | | | 88.24 | 6 |

The C content was adjusted to be within the two phase region hex(MeC)+ binder or hex (MeC)+cub(MeC)+binder (Me is the Metals in table 1 above) as known in the art. The samples were made accordingly:

The powder was milled in a ball mill for 8 h with a rotation speed of 146 rpm. The milling was carried out in wet conditions, using ethanol, with an addition of 2 wt % polyethylene glycol (PEG 40) as organic binder. A WC—Co-lined mill of 0.25 l in volume and 800 g cylpebs, both made of WC—Co. After milling, the slurry was dried at 80° C. for at least 300 min in nitrogen atmosphere. The green body was produced by uniaxial pressing and was sintered by using HIP at 1410° C. for 1 hour.

In table 2A (below) is the overall composition recalculated into grams of respective raw material before sintering.

TABLE 2A
Weight composition before sintering in g.

| Sample | (W, Ta)C | TaC | (W, Cr)C | Cr₃C₂ | WC | W | Co |
|---|---|---|---|---|---|---|---|
| 1 | 93.14 | | | | | | 6.00 |
| 2 | | 0.84 | | | 93.20 | | 6.18 |
| 3 | | | 90.91 | | | 3.03 | 6.00 |
| 4 | | | | 0.68 | 92.6 | 0.75 | 6.18 |
| 5 | 46.78 | | 45.24 | | 1.01 | 1 | 6.18 |
| 6 | | 0.42 | | 0.34 | 93.13 | 0.14 | 6.19 |
| 7 | | | | | 100.27 | 0.36 | 6.42 |

Two additional samples were also studied, both containing 1.22 wt % Ta and 12 wt % Co, see table 2B. They were made as describe above.

TABLE 2B
Additional samples: Sample 8 is doped.

| Sample | |
|---|---|
| 8 | (W, Ta)C + Co |
| 9 | WC + TaC + Co |

Sample Preparation

The samples were prepared by standard metallographic techniques, including a final polishing step with a 1 μm diamond slurry for 20 minutes until all visible scratches were gone. After polishing the samples were observed by LOM in a Olympus BX51M both unetched and etched. The etchant used was Murakami's reagent.

Nano-Indentation

Prior to the nano-indentation testing, the samples were polished with a final step of 0.25 μm diamond paste. The measurements were performed approximately in the center of the material, using a Nano-hardness Tester, NTH, S/N: 06-134 with XYZ sample stage and a diamond Berovich indenter tip. Hardness was determined by the load-displacement curves suing the Oliver-Pharr method. To identify the target area a SEM of model Zeiss, Supra 40, was used. The analysis of the nano-indentation indents were carried out using secondary electrons. The electron beam was set at 15 kV in order to detect the number and indent surface from the nano-indenter.

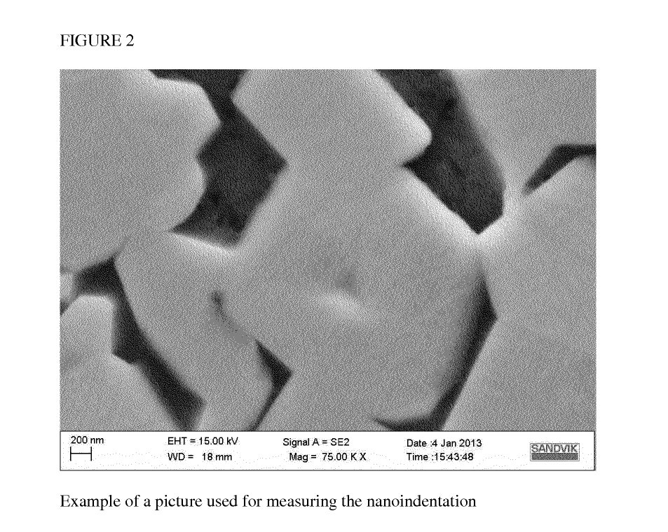

Nanoindentation for the samples was performed by using a load of 5 mN. 50 impressions were made on each sample and the three best hits, where the indent is entirely inside the crystal were used for hardness and E-modulus (see FIG. 2). A good hit were identified as a clear impressions in the WC phase, with a significant distance from the grain boundaries. The result is shown in table 3.

TABLE 3
The result of the nano indentation

| | Average hardness result of |
|---|---|
| Sample | nano indentation [GPa] |
| 1 | 28.5 |
| 2 | 39.7 |
| 3 | 27.3 |
| 4 | 34.3 |
| 5 | 31.7 |
| 6 | 34.3 |
| 7 | 37.1 |
| 8 | 30.5 |

The doped WC grains had overall according to the nano-indentation a constant lower hardness compared to the undoped grains (see table 3). The hardest WC grain, according to these measurements, is the undoped samples, having the hardness ranges between 39 GPa and 34 GPa, while the doped WC grains had a hardness of 28 GPa and 27 GPa. It should be noted that although the Cr-doped sample had the highest microhardness, there is according to the results no correlation between the hardness of the grains themselves and the hardness of the matrix, giving that at equal WC grain size, the doped material will give a lower microhardness compared to the undoped. Thus, to reach equal hardness, a lower Co-content could be used and thereby the wear resistance of the alloy increases as the hard phase amount is increased.

Additionally, Table 4 shows that the doped carbides clearly have a lower amount of cubic carbide precipitates measured as area intercept on 10 images after sintering.

TABLE 4

| | Ta | Cr | area Intercept |
|---|---|---|---|
| Sample | [wt %] | [wt %] | amount of cubic phase |
| 1 | 0.79 | | 1.1 |
| 2 | 0.79 | | 1.5 |
| 5 | 0.39 | 0.3 | 0.2 |

The Sintered Material

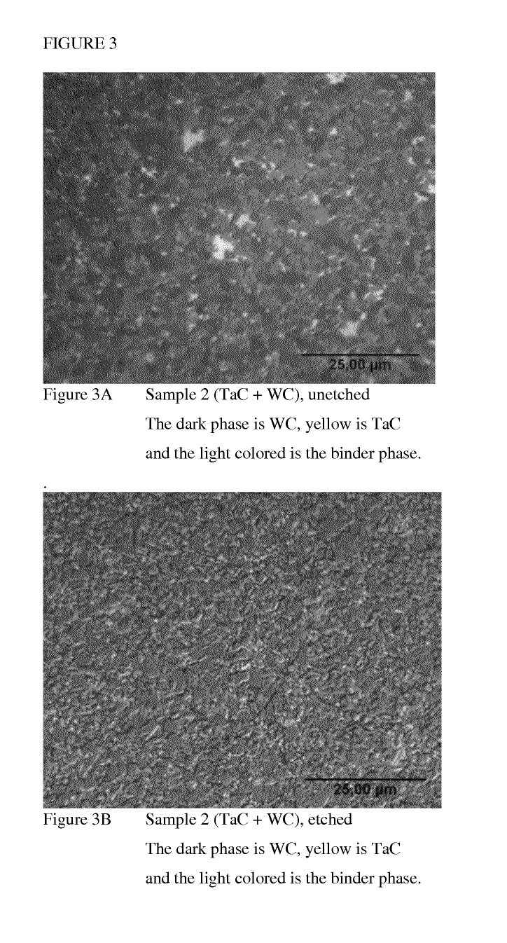

In the alloy of (W,Ta)C and Co, Sample 1, a cubic carbide phase visible. The phase is seen as yellow and is a result of tantalum dissolved from the (W,Ta)C and precipitated as cubic carbides (see FIGS. 3A and 3B. The amount of cubic carbide was calculated using a grid. The vol % was 1.2.

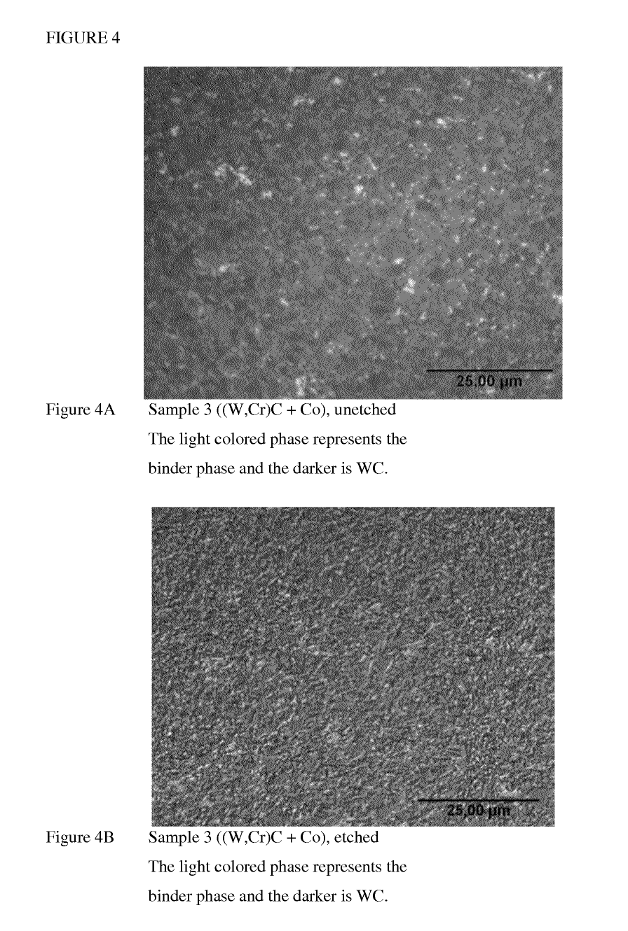

In the samples containing Cr no obvious cubic carbide are visible, as seen in FIGS. 4A and 4B.

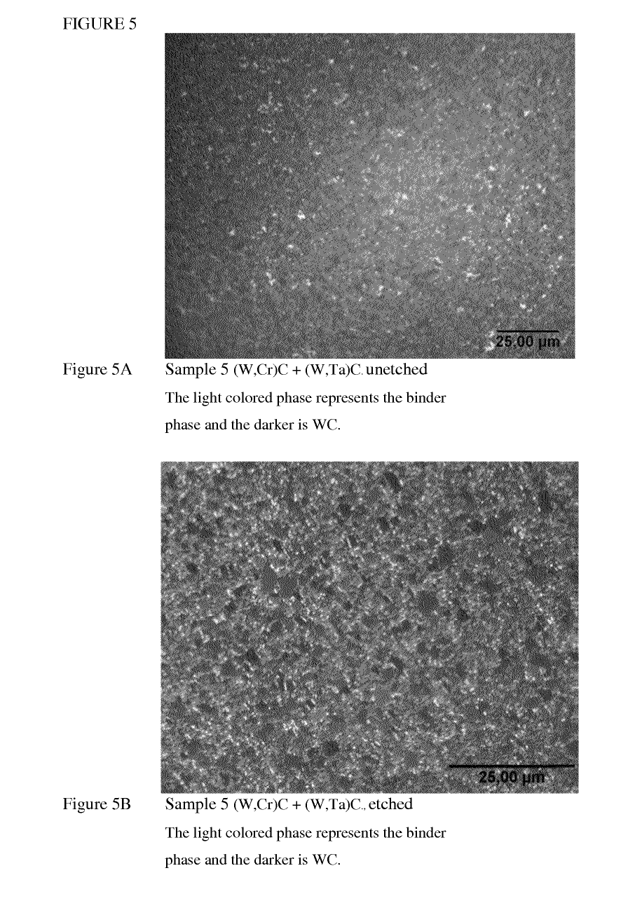

The mixed samples containing (W,Cr)C and (W,Ta)C, Sample 5, and WC+Cr₃C₂+TaC, Sample 7, had pores and some cubic carbides, see FIGS. 5A and B and 6A and B. The vol % of carbides were Sample 5 0.3 vol % TaC and for Sample 6 0.4 vol % TaC.

Microhardness Measurements

Hardness measurements were performed with a Future-Tech Vickers hardness tester FV-300 on samples polished with 1 μm diamond slurry. Three measurements were made on each sample with a load of 30 kg and with 2 mm as distance between each measurement. The results from the microhardness test are listed in table 5.

TABLE 5
Microhardness

| Sample | Hardness [HV30] |
|---|---|
| 1 | 1518 |
| 2 | 1592 |
| 3 | 1724 |
| 4 | 1603 |
| 5 | 1698 |
| 6 | 1719 |
| 7 | 1494 |
| 8 | 1393 |
| 9 | 1382 |

As can be seen from the table 5, Cr doped WC proved to have the hardest matrix, harder than the Cr-reference and the undoped sample. The hardness of the matrix might thereby be a consequence of a low WC grain size more than the hardness of the WC grains.

The hardness of the Cr- and Ta-doped WC grains is significant lower than the undoped reference sample according to the nano-indentation results. The result is unexpected since there is precipitation of TaC due to Ta dissolved from the doped WC grains, this would lead to values close to the undoped grains. The doped grains had both the highest plastic deformation and extrapolated contact depth.

The result is unexpected since both the Ta and Cr doped crystals are less cubic than the undoped powder, they should thereby have less sliding system and more tensions. The results gained by the nano-indentation measurements are difficult to validate as the true hardness mainly because of two reasons. Firstly the WC grain target areas crystallographic orientation has not been identified. Therefore an average of all indents has been set as the hardness of WC. Secondly the indentation size effect makes it difficult to compare with previous research since different loads and thereby indents depth affects the results. However, the results from the nano-indentation could still be compared among the samples in this study since they have been measured under/with the same conditions.

1. A process of manufacturing a cemented carbide, said process comprising the steps of:
a) forming a slurry including a milling liquid, binder metal and hard constituents, wherein said hard constituents include hex doped WC;
b) subjecting said slurry to milling and drying to form a powder mixture; and
c) subjecting the powder mixture to pressing and sintering, wherein the hex doped WC is subjected to nitrogen before and/or during sintering.

2. The process of manufacturing a cemented carbide according to claim 1, wherein the hex doped WC is subjected to nitrogen gas before sintering.

3. The process of manufacturing a cemented carbide according to claim 1, wherein the hex doped WC is subjected to nitrogen gas during sintering.

4. The process of manufacturing a cemented carbide according to claim 1, wherein the hex doped WC is doped with a transition metal selected from Ta, Nb, Cr and mixtures thereof.

5. The process of manufacturing a cemented carbide according to claim 4, wherein said transition metal is Ta and/or Cr.

6. The process of manufacturing a cemented carbide according to claim 1, wherein the binder metal is selected from the group of Cr, Mo, Fe, Co and Ni.

7. The process of manufacturing a cemented carbide according to claim 1, wherein said binder metal is Co.

8. The process of manufacturing according to claim 1, wherein said cemented carbide includes WC and hex doped WC in the range of from 65 to 90 wt %, Co in the range of from 3 to 15 wt % and Ta in the range of from 1 to 5 wt %. and Cr in the range of 0 to 20 wt % .

9. A process of manufacturing of a cemented carbide cutting tool comprising the steps of:
forming a slurry including a milling liquid, binder metal and hard constituents, wherein said hard constituents include hex doped WC;
subjecting the slurry to milling and drying to form a powder mixture; and
subjecting the powder mixture to pressing and sintering, wherein the hex doped WC is subjected to nitrogen before and/or during sintering.

10. A cemented carbide obtainable according to the process of claim 1.

11. A cemented carbide according to claim 10 which, wherein the cemented carbide is a straight cemented carbide comprising hex doped WC.

12. (canceled)
